(19) United States
(12) Patent Application Publication
(10) Pub. No.: US 2015/0232497 A1
(43) Pub. Date: Aug. 20, 2015

(54) METHOD FOR ESTERIFYING LIGNIN WITH AT LEAST ONE FATTY ACID

(71) Applicant: UPM-Kymmene Corporation, Helsinki (FI)

(72) Inventors: Suvi Pietarinen, Lappeenranta (FI); Teemu Myllymäki, Helsinki (FI); Kati Oinonen, Imatra (FI)

(21) Appl. No.: 14/421,916

(22) PCT Filed: Aug. 22, 2013
(86) PCT No.: PCT/FI2013/050818

§ 371 Date: Feb. 16, 2015

(30) Foreign Application Priority Data
Aug. 24, 2012 (FI) 20125879

(51) Int. Cl. C07G 1/00

(52) U.S. Cl. CPC C07G 1/00

(57) ABSTRACT

The present invention relates to a method for producing lignin esterified with at least one fatty acid, wherein the method includes the following steps: (i) reacting acetylated lignin with at least one fatty acid under the influence of heating and distilling at least part of the acetic acid formed during the reaction away from the reaction mixture, wherein per each mole of acetyl groups present in the lignin an excess molar amount of at least one fatty acid is used; and (ii) recovering lignin esterified with at least one fatty acid formed in step (i).

### FIELD OF THE INVENTION

The invention relates to a method for esterifying lignin with at least one fatty acid. The invention further relates to lignin esterified with at least one fatty acid and to the use thereof.

### BACKGROUND OF THE INVENTION

Lignin is a natural polymer, which can be extracted from e.g. wood. As lignin is a natural biopolymer its use as a component in e.g. glues and other applications instead of synthetic materials has been investigated in order to come up with more environmentally friendly applications.

Different types of methods have been proposed to modify the properties of lignin to be used in different applications. As one example, it has been attempted to esterify lignin with fatty acids. However, these methods have involved e.g. chlorination of fatty acids, several reaction steps or harsh reaction conditions.

The inventors have therefore recognized a need for a method, which would enable the production of esters of fatty acids and lignin with desired properties by using a user-friendly method.

### PURPOSE OF THE INVENTION

The purpose of the invention is to provide a new type of method for forming esters of lignin and at least one fatty acid. Further, the purpose of the invention is to provide lignin esterified with at least one fatty acid. Further, the purpose of the invention is to provide new uses of lignin esterified with at least one fatty acid.

### SUMMARY

The method according to the present invention is characterized by what is presented in claim 1.

The lignin esterified with at least one fatty acid according to the present invention is characterized by what is presented in claim 14.

The uses according to the present invention are characterized by what is presented in claim 15 and in claim 16.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart illustration of a method according to one embodiment of the present invention; and

FIG. 2, FIG. 3 and FIG. 4 show the IR spectra of acetylated lignin, TOFA and the formed ester, respectively.

### DETAILED DESCRIPTION OF THE INVENTION

The present invention relates to a method for producing lignin esterified with at least one fatty acid, wherein the method comprises the following steps:

(i) reacting acetylated lignin with at least one fatty acid under the influence of heating and distilling at least part of the acetic acid formed during the reaction away from the reaction mixture, wherein per each mole of acetyl groups present in the lignin an excess molar amount of at least one fatty acid is used; and
(ii) recovering lignin esterified with at least one fatty acid formed in step (i).

In this specification, unless otherwise stated, the expression “lignin” should be understood as any lignin suitable to be used in the present invention including essentially pure lignin as well as lignin derivatives and lignin modifications.

By the expression “essentially pure lignin” should be understood as at least 90% pure lignin, preferably at least 95% pure lignin. In one embodiment of the present invention the essentially pure lignin comprises at most 10%, preferably at most 5%, of other components. Extractives and carbohydrates such as hemicelluloses as well as inorganic matter can be mentioned as examples of such other components.

The lignin used in the method according to the present invention is acetylated before being reacted with the at least one fatty acid. I.e. acetylated lignin is used in the method for preparing lignin esters. Acetylation describes a reaction that introduces at least one acetyl functional group into a chemical compound. During the acetylation of lignin the phenolic OH and aliphatic OH of lignin is reacted with acetic anhydride thereby forming acetate ester with the phenol. Acetylated lignin comprises acetyl groups and these acetyl groups can react with alcohols or carboxylic acids. The advantage of using acetylated lignin in the method according to the present invention is that the lignin is more reactive in the reaction with the at least one fatty acid, such as tall oil fatty acids. The acetate group is a reactive leaving group when reacted with the at least one fatty acid.

In one embodiment of the present invention the method comprises, before step (i), forming acetylated lignin by reacting lignin with acetic anhydride.

In one embodiment of the present invention the at least one fatty acid comprises at least one fatty acid comprising 4-28, preferably 8-22 carbon atoms. In one embodiment of the present invention the at least one fatty acid comprises at least one dicarboxylic fatty acid. Alpha, omega-fatty acids containing a carboxyl group in both ends of the aliphatic chain can be mentioned as examples. These kinds of fatty acids can be found in suberin.

In one embodiment of the present invention the at least one fatty acid is selected from a group consisting of tall oil fatty acids (TOFA), the fatty acid composition present in suberin, and any combination thereof. In one embodiment of the present invention the at least one fatty acid comprises tall oil fatty acids (TOFA).

In one embodiment of the present invention tall oil fatty acids (TOFA) are used. Tall oil is a product, which can be obtained e.g. as a byproduct of wood pulp manufacture process. Tall oil fatty acids can be obtained e.g. as by-product from the Kraft process of wood pulp manufacture after distillation of tall oil. The advantage of tall oil fatty acids as a raw material in different applications is that it is inexpensive and readily available. The composition of crude tall oil varies depending on the wood furnish used. Tall oil fatty acids comprise a group of fatty acids with 16-20 carbon atoms. In one embodiment of the present invention the tall oil fatty acids comprise linoleic acid, oleic acid, and rosin acids.

In one embodiment of the present invention suberin is used to react with the acetylated lignin. Suberin can be isolated from e.g. birch bark. The composition of suberin may vary depending on the source from which it is isolated. Suberin contains a mixture of fatty acids. Fatty acids of suberin isolated from birch bark can comprise 20-26 carbon atoms. Suberin can comprise aliphatic fatty acids, dicarboxylic acids and fatty acid alcohols.

In the method according to the present invention per each mole of acetyl groups in the lignin used, an excess molar amount of at least one fatty acid should be used in order to ensure that the chemical reaction is complete. In one embodiment of the present invention the molar ratio of acetylated lignin to at least one fatty acid is 1-15, preferably 1-6, and more preferably 1-3.

In one embodiment of the present invention step (i) is performed at a temperature of 70-125° C., preferably at a temperature of 80-120° C., and more preferably at a temperature of 100-110° C.

In one embodiment of the present invention step (i) is continued for 5-60 minutes, preferably for 10-20 minutes.

In one embodiment of the present invention step (i) is carried out in the presence of a solvent. In one embodiment of the present invention the solvent used in step (i) is selected from a group consisting of toluene, hexane, pyridine, and any combination thereof.

In one embodiment of the present invention step (i) is carried out in the presence of a catalyst. In one embodiment of the present invention the catalyst is selected from a group consisting of pyridine, 1-methylimidazole, and any combination thereof. In one embodiment of the present invention the catalyst is pyridine.

Distillation of the acetic acid formed during the reaction between acetylated lignin and at least one fatty acid shifts the balance of the reaction towards the lignin-fatty acid ester formation.

In one embodiment of the present invention step (ii) of recovering the lignin esterified with at least one fatty acid comprises distilling the reaction mixture from step (i) under vacuum; subjecting the reaction mixture from step (i) to drying in a vacuum oven; subjecting the reaction mixture from step (i) to spray drying; and/or subjecting the reaction mixture from step (i) to centrifugation.

In one embodiment of the present invention step (ii) of recovering lignin esterified with at least one fatty acid comprises mixing the reaction mixture with a solvent for precipitating the lignin esterified with at least one fatty acid.

In one embodiment of the present invention the precipitate formed in step (ii) is filtered.

In one embodiment of the present invention the solvent used in step (ii) is an organic solvent or water. In one embodiment of the present invention step (ii) comprises extraction with an organic solvent. In one embodiment of the present invention the organic solvent used in step (ii) is selected from a group consisting of lipophilic solvents, ethers, alcohols, hydrocarbons, and any combination thereof. In one embodiment of the present invention the organic solvent used in step (ii) is selected from a group consisting of acetone, pentane, hexane, heptane, methanol, ethanol, propanol, butanol, pentanol, toluene, any water mixture thereof, and any combination thereof.

In one embodiment of the present invention the method further comprises step (iii) of drying the lignin esterified with at least one fatty acid recovered in step (ii). In one embodiment of the present invention the method further comprises step (iii) of drying the lignin esterified with at least one fatty acid recovered in step (ii) in vacuum, in an oven, and/or at room temperature under ventilation.

In one embodiment of the present invention the lignin to be used in the method is selected from a group consisting of kraft lignin, biomass originating lignin, lignin from alkaline pulping process, lignin from soda process, lignin from organosols pulping and any combination thereof.

Different lignin components may have different properties, e.g. molecular weight, molar mass, polydispersity, hemicellulose and extractive contents.

By “kraft lignin” is to be understood in this specification, unless otherwise stated, lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different techniques including e.g. precipitation and filtration. Lignin usually begins precipitating at pH values below 11-12. Different pH values can be used in order to precipitate lignin fractions with different properties. These lignin fractions may differ from each other by molecular weight distribution, e.g. Mw and Mn, polydispersity, hemicellulose and extractive contents, contents of inorganic material. The precipitated lignin can be purified from inorganic impurities, hemicellulose and wood extractives using acidic washing steps. Further purification can be achieved by filtration.

In one embodiment of the present invention the lignin is separated from pure biomass. The separation process can begin with liquidizing the biomass with strong alkali followed by a neutralization process. After the alkali treatment the lignin can be precipitated in a similar manner as presented above. In one embodiment of the present invention the separation of lignin from biomass comprises a step of enzyme treatment. The enzyme treatment modifies the lignin to be extracted from biomass. Lignin separated from pure biomass is sulphur-free and thus valuable in further processing.

The method of the present invention surprisingly results in the formation of lignin esterified with at least one fatty acid having new properties suitable for different applications. Without limiting the invention to any specific theory about why the method of the present inventions results in the aforementioned advantage, it is to be considered that the formation of lignin esterified with at least one fatty acid is due to the fact that lignin is acetylated before it is used in the reaction with at least one fatty acid. Further it was noted that the formation of ester bonds was enabled by allowing the at least one fatty acid to react directly, i.e. without being e.g. pretreated by catalysis procedures.

The precise order of combining and/or adding the components needed for the method or the reaction steps thereof may vary depending e.g. on the lignin source used. The choice of the sequence of combining and/or adding the required components is within the knowledge of the skilled person based on this specification. The precise amount of the components used for producing the lignin esterified with at least one fatty acid may vary and the choice of the amounts of the different components is within the knowledge of the skilled person based on this specification.

When determining the amounts of the components to be used in the production of lignin esterified with at least one fatty acid, it should be taken into consideration that the at least one fatty acid should be present in an excess amount, in relation to the acetyl groups in the lignin, in the reaction mixture in order to ensure a high yield of produced esters.

The present invention further relates to lignin esterified with at least one fatty acid obtainable by the method according to the present invention. The inventors surprisingly found that lignin esterified with e.g. tall oil fatty acids has novel and advantageous properties compared to untreated lignin. As an example only it can be mentioned that the hydrophobicity of the produced lignin esters is increased compared to untreated lignin making the lignin esters suitable e.g. for barrier applications. The formed lignin esters have a low melting point resulting in advantageous mouldability properties when used in a composite structure.

The present invention further relates to the use of lignin esterified with at least one fatty acid according to the present invention for the production of a composite or a barrier film. As an example only, it can be mentioned that said esterified lignin can be used in barrier applications to provide hydrophobicity in wood composite structures or in barrier films applied on a paper or a wood surface.

The present invention further relates to the use of lignin esterified with at least one fatty acid according to the present invention for the production of a binder composition or an adhesive composition.

The embodiments of the invention described hereinbefore may be used in any combination with each other. Several of the embodiments may be combined together to form a further embodiment of the invention. A method, lignin esterified with at least one fatty acid or a use, to which the invention is related, may comprise at least one of the embodiments of the invention described hereinbefore.

An advantage of the method according to the present invention is that it is possible to produce esters of lignin with at least one fatty acid, which have novel properties compared to untreated lignin. For example high hydrophobicity and mouldability of the final product can be achieved.

An advantage of the method according to the present invention is that it is possible to produce a material, i.e. lignin esterified with at least one fatty acid, to be used in barrier films and in composite materials.

An advantage of the present invention is that the formed product can be used during the production of further applications such as humidity resistant packaging. Lignin esterified with at least one fatty acid is a suitable material for coating of packaging materials as the esterified lignin is able to reduce water vapour and oxygen transmission rates.

### EXAMPLES

Reference will now be made in detail to the embodiments of the present invention, an example of which is illustrated in the accompanying drawing.

The description below discloses some embodiments of the invention in such a detail that a person skilled in the art is able to utilize the invention based on the disclosure. Not all steps of the embodiments are discussed in detail, as many of the steps will be obvious for the person skilled in the art based on this specification.

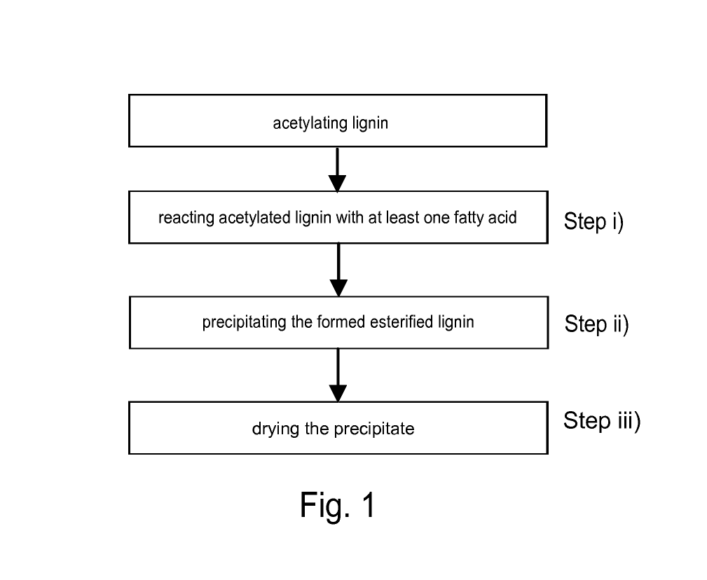

FIG. 1 illustrates a method according to one embodiment of the present invention for producing lignin esterified with at least one fatty acid.

Before allowing the reaction to take place between the lignin and the at least one fatty acid the source and the amounts of the components used in the method are chosen.

Following various preparations lignin is acetylated by allowing the selected lignin to react with acetic anhydride in order to form acetylated lignin.

Following the formation of acetylated lignin, step (i) is carried out. In step (i) the treated lignin is cooked together with an excess amount of at least one fatty acid at a temperature of 70-125° C. At least part of the acetic acid formed during this reaction is distilled away from the reaction mixture. Distillation of the acetic acid shifts the balance of the reaction towards the lignin-fatty acid ester formation.

The reaction of step (i) is allowed to continue for 10-60 minutes, after which the reaction mixture is mixed with a solvent resulting in the lignin esterified with at least one fatty acid being precipitated. The formed precipitate is then filtered.

Thereafter, step (iii) is carried out. Step (iii) comprises drying the formed precipitate. The drying step can be carried out in vacuum, in an oven, or at room temperature under ventilation. The precipitate may also be purified by methods, which are readily available to a person skilled in the art.

### Example 1

### Producing Lignin Esters of Tall Oil Fatty Acids

In this example lignin esterified with tall oil fatty acids (TOFA) was produced. The following components and their amounts were used:

| | amount | |
|---|---|---|
| TOFA | 50 | g |
| acetylated lignin | 10 | g |
| toluene | 100 | ml |

Acetylated lignin and tall oil fatty acids (TOFA) were mixed together and allowed to react in toluene at a temperature of 110° C. Acetic acid formed during the cooking was distilled away from the reaction mixture in order to shift the balance of the reaction to the lignin-fatty acid ester formation. The reaction mixture was cooked for about 30 minutes after which the reaction mixture was allowed to cool. The cooled reaction mixture was mixed with solvent resulting in a sediment or precipitate containing lignin esters of tall oil fatty acids being formed. Then the sediment was purified with repeated washing steps and dried. The formed sediment had a rubbery consistency.

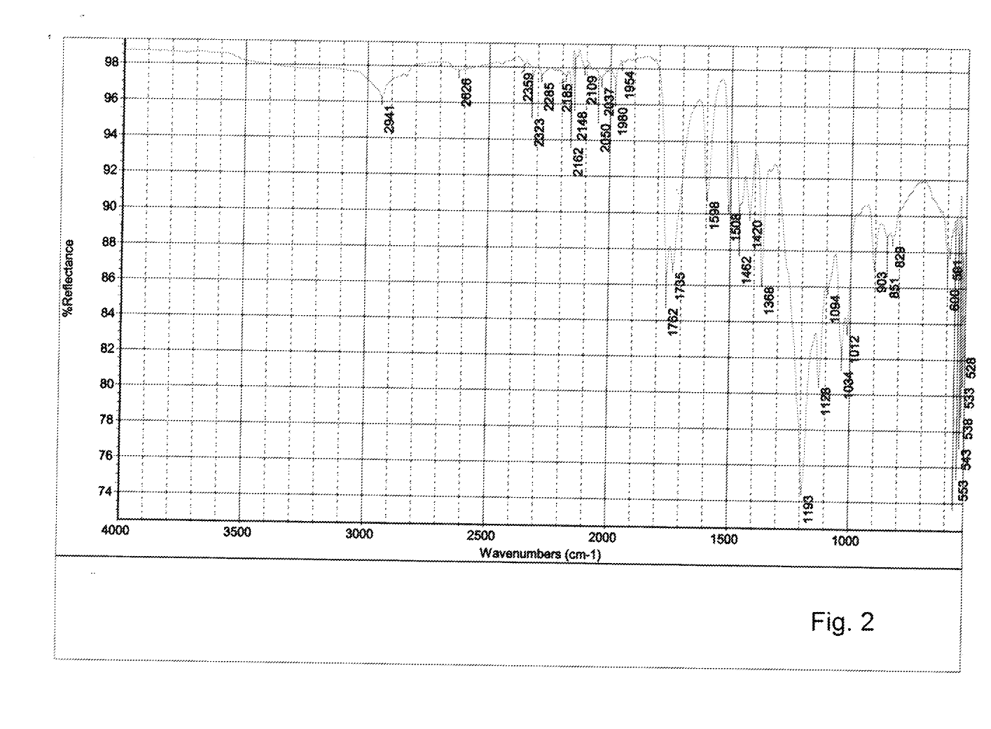

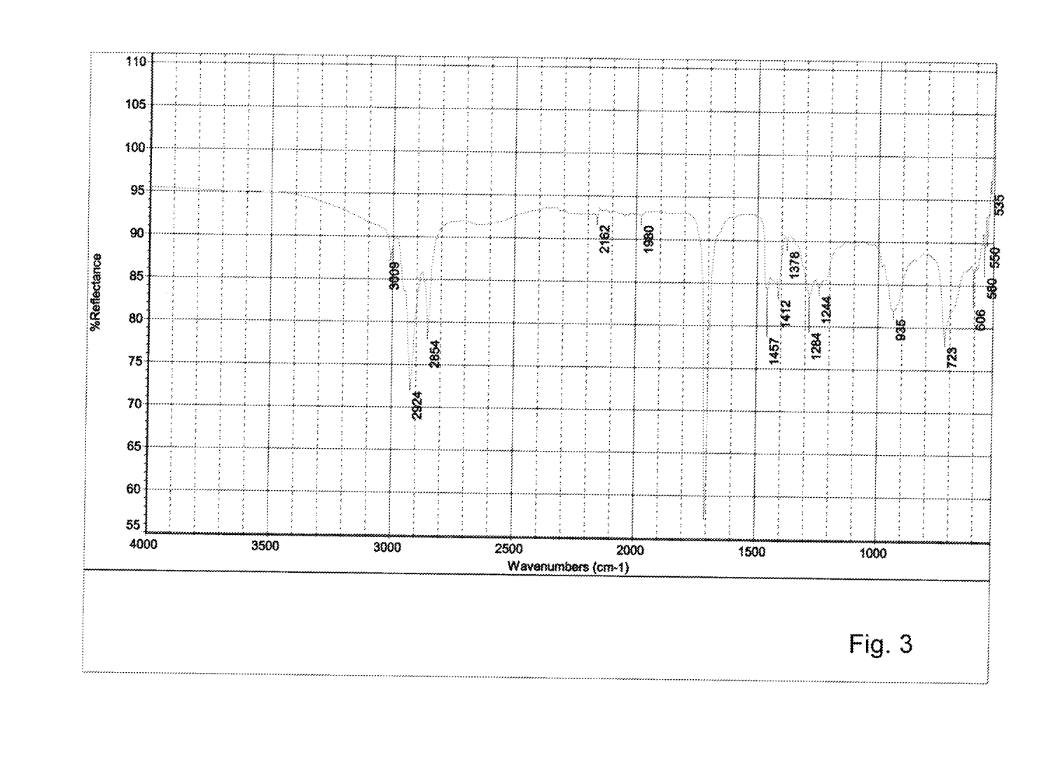

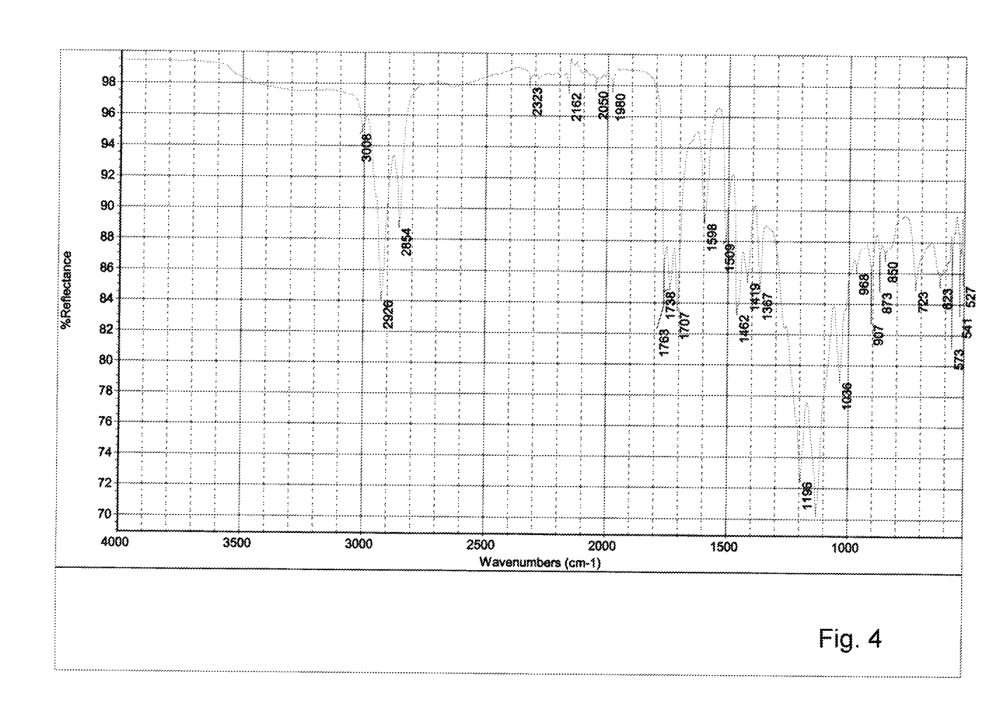

The analysis results of the sediment by e.g. IR showed that ester bonds were present in the material (see FIGS. 2, 3 and 4 disclosing the IR spectra of acetylated lignin, TOFA and the formed ester, respectively). The formed esters had a low melting point of 60-65° C. The ester material had a rubbery-like consistency and a pleasant smell.

In examples 1-4 acetylated lignin was used to react with the at least one fatty acid. The acetylated lignin was prepared by allowing the selected lignin to react with acetic anhydride. The acetylation was carried out by suspending 2 g of the selected lignin in 10 ml of acetic anhydride and heating the formed suspension for 2 hours at 80° C. Then the acetic anhydride was evaporated, the lignin was washed with methanol and air dried.

### Example 2

### Producing Lignin Esterified with Fatty Acids Present in Suberin

In this example lignin esterified with fatty acids present in suberin was produced. The suberin used had been isolated from birch bark. The following components and their amounts were used:

| | amount | |
|---|---|---|
| Suberin | 5 | g |
| acetylated lignin | 10 | g |
| pyridine | 100 | ml |

Acetylated lignin and suberin were mixed together in pyridine and allowed to react at a temperature of about 120° C. Acetic acid formed during the cooking was distilled away from the reaction mixture in order to shift the balance of the reaction to the lignin-fatty acid ester formation. The reaction mixture was cooked for about one hour after which the reaction mixture was allowed to cool. The cooled reaction mixture was poured into water, whereby a light brown precipitate containing lignin esterified with fatty acids present in suberin was formed.

Then the sediment was purified with repeated washing steps and dried.

The analysis results of the sediment by e.g. IR showed that ester bonds were present in the material. The formed esters had a low melting point of 40-70° c.

### Example 3

### Producing Lignin Esters of Tall Oil Fatty Acids

In this example lignin esterified with tall oil fatty acids (TOFA) was produced. The following components and their amounts were used:

| | amount |
|---|---|
| TOFA | 100 g |
| acetylated lignin | 20 g |

The reaction between acetylated lignin and tall oil fatty acids was carried out in a similar manner as presented in Example 1, except that no solvent was used for carrying out the reaction. The reaction was carried out at a temperature of 125° C. and some acetic acid was distilled away from the reaction mixture.

The reaction mixture was allowed to cool and then poured into hexane whereby the formed lignin-fatty acid ester was precipitated. The precipitate was washed and dried.

### Example 4

### Producing Lignin Esters of Tall Oil Fatty Acid

In this example lignin esterified with tall oil fatty acids (TOFA) was produced. The following components and their amounts were used:

| | amount | |
|---|---|---|
| TOFA | 10 | g |
| acetylated lignin | 10 | g |
| toluene | 100 | ml |
| pyridine | 5 | ml |

Acetylated lignin and tall oil fatty acids (TOFA) were mixed together in toluene and allowed to react at a temperature of 110° C. in the presence of pyridine. Pyridine acted as a catalyst for the reactions taking place in the reaction mixture and neutralized the formed acetic acid. Even though pyridine neutralized the formed acetic acid, the formed acetic acid was distilled away from the reaction mixture in order to shift the balance of the reaction towards the lignin-fatty acid ester formation. The reaction mixture was cooked until 80 ml of toluene together with pyridine and acetic acid was distilled off. Thereafter the reaction mixture was allowed to cool. The cooled reaction mixture was mixed with hexane (300 ml) resulting in a light brown precipitate being formed. The product was filtered, washed with hexane and ethanol, and dried at a temperature of 60° C.

### Example 5

### The Use of Lignin Esters of Tall Oil Fatty Acids in Barrier Application

The lignin esters of tall oil fatty acids produced in example 1 were used for preparing a barrier film on a paperboard.

The formed lignin ester material was coated on a paperboard (200-290 g/m²) using an Erichsen film applicator (wire diameter was 40 μm and speed 18 mm/s). The samples were dissolved in organic solvent to 10 weight-%. Water Vapor Transmission Rate (WVTR) and Oxygen Transmission Rate (OTR) tests of the lignin ester coated paperboard were performed. The values received were compared with values from control samples.

The results showed that the formed lignin ester coatings had excellent water vapor and oxygen barrier properties on the paperboard. It was noted that the lignin ester coatings increased the surface hydrophobicity compared to uncoated board.

### Example 6

### The Use of Lignin Esters of Tall Oil Fatty Acids in Gluing Application

In this example the lignin esters formed in example 1 were used in the production of a binder composition.

The lignin esters were reacted with e.g. a polymerizable substance and a crosslinking agent in a manner readily available to a person skilled in the art for producing a binder composition. The binder composition was applied to a board and to a paper and was allowed to cure at 135° C. for 3 minutes. Thereafter the pieces were pulled together.

It was recognized that the binder composition had excellent gluing properties.

### Example 7

### The Use of a Binder Composition for the Production of an Adhesive Composition

The binder composition formed in example 6 was used for the production of an adhesive composition. The binder composition was mixed e.g. with suitable extenders, fullers, catalysts, additives, as examples of which e.g. starch, wood flour and hardener (e.g. tannin or carbonates) can be mentioned, thus forming the adhesive composition.

The adhesive composition was used for gluing together wood veneers having the thickness of below 3 mm for producing a 7-plywood. Results showed that the gluing effect was sufficiently good for gluing wood veneers.

It is obvious to a person skilled in the art that with the advancement of technology, the basic idea of the invention may be implemented in various ways. The invention and its embodiments are thus not limited to the examples described above; instead they may vary within the scope of the claims.

1. A method for producing lignin esterified with at least one fatty acid, wherein the method comprises the following steps:
(i) reacting acetylated lignin with at least one fatty acid under the influence of heating and distilling at least part of the acetic acid formed during the reaction away from the reaction mixture, wherein per each mole of acetyl groups present in the lignin an excess molar amount of at least one fatty acid is used; and
(ii) recovering lignin esterified with at least one fatty acid formed in step (i).

2. The method of claim 1, wherein the method comprises, before step (i), forming acetylated lignin by reacting lignin with acetic anhydride.

3. The method of claim 1, wherein the molar ratio of acetylated lignin to at least one fatty acid is 1.

4. The method of claim 1, wherein step (i) is performed at a temperature of 70-125° C.

5. The method of claim 1, wherein step (i) is continued for 5-60 minutes.

6. The method of claim 1, wherein step (i) is carried out in the presence of a solvent.

7. The method of claim 1, wherein step (i) is carried out in the presence of a catalyst.

8. The method of claim 1, wherein step (ii) of recovering the lignin esterified with at least one fatty acid comprises mixing the reaction mixture with a solvent for precipitating the lignin esterified with at least one fatty acid.

9. The method of claim 1, wherein step (ii) of recovering the lignin esterified with at least one fatty acid comprises distilling the reaction mixture from step (i) under vacuum; subjecting the reaction mixture from step (i) to drying in a vacuum oven; subjecting the reaction mixture from step (i) to spray drying; and/or subjecting the reaction mixture from step (i) to centrifugation.

10. The method of claim 1, wherein the solvent used in step (ii) is an organic solvent or water.

11. The method of claim 1, wherein the method further comprises step (iii) of drying the lignin esterified with at least one fatty acid, recovered in step (ii), in vacuum, in an oven, and/or at room temperature under ventilation.

12. The method of claim 1, wherein the at least one fatty acid comprises at least one fatty acid comprising 4-28 carbon atoms.

13. The method of claim 1, wherein the at least one fatty acid is selected from the group consisting of tall oil fatty acids (TOFA), the fatty acid composition present in suberin, and any combination thereof.

14. Lignin esterified with at least one fatty acid obtainable by the method of claim 1.

15. A composite or a barrier film comprising the lignin esterified with at least one fatty acid of claim 14.

16. A binder composition or an adhesive composition comprising the lignin esterified with at least one fatty acid of claim 14.

17. The method of claim 1, wherein the molar ratio of acetylated lignin to at least one fatty acid is 1-6.

18. The method of claim 1, wherein the molar ratio of acetylated lignin to at least one fatty acid is 1-3.

19. The method of claim 1, wherein step (i) is performed at a temperature of 100-110° C.

20. The method of claim 1, wherein step (i) is continued for 10-20 minutes.
